(19) United States
(12) Patent Application Publication
(10) Pub. No.: US 2007/0223862 A1
(43) Pub. Date: Sep. 27, 2007

(54) Coupling Device for a Light Guide

(76) Inventor: Reinhardt Thyzel, Heroldsberg (DE)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/569,652

(22) PCT Filed: Oct. 20, 2005
(86) PCT No.: PCT/EP05/11291

§ 371 Date: Nov. 27, 2006

(30) Foreign Application Priority Data
Dec. 15, 2004 (DE) 10 2004 060 761.3

(51) Int. Cl. G02B 6/26

(52) U.S. Cl. 385/50

(57) ABSTRACT

A coupling device includes a first coupling element having a first passage, and an end section connected to the free end of the light guide; as well as a second coupling element with a second passage for holding/fixing an intermediate section following the end section of the light guide. In one implementation, the first coupling element and the second coupling element can be detachably joined in a coupled state, where the first passage and the second passage form a common passage and/or have (or surround) a common longitudinal axis. The first passage can be configured with a funnel-shaped section that, in the coupled state, the first passage faces the second passage and widens toward the second passage. In addition, the first coupling element may be formed from ceramic material at least on its inner surface in the region of the funnel-shaped section.

The invention relates to a coupling device for connecting a light guide.

Optical coupling devices, in particular plug-in connections or screw connections, are known for optically connecting a light guide, for example an optical fiber, to other optical components or further light guides. In order to ensure a reliable transmission of the light, the light guide and the further optical component or the two light guides must be joined to one another or aligned with one another with particular accuracy with reference to the light propagation direction or the optical axes in the coupling device so that the light or the light signal is transmitted as completely as possible. Moreover, especially at their particularly sensitive ends, the sensitive optical fibers must be protected against mechanical damage.

One possible application of light guides is for transmitting light, in particular laser light, for processing materials or for the medical treatment of humans or animals, in particular in ophthalmology, for example in the explantation of the natural eye lens during cataract operations in the course of the phacoemulsification during which shock waves produced by means of laser light emulsify the lens and are exhausted (photolysis), or in operations on the cornea, for example for treating myopia.

Another application is the transmission of information relating to light signals through light guides in metrology, communications technology and data systems technology.

EP 0 898 186 A1 discloses a plug-in connection for centered connection of a light guiding fiber, or for centered coupling of two light guiding fibers, that has a plug and a socket with a cutout in which the plug engages. The light guiding fiber is led through the socket and ends with a fiber end in a bore in the plug that expands in a funnel-shape fashion in the direction of the socket. In order to protect it against mechanical damage, the optical fiber is rigidly held in a tube that surrounds the fiber inside the bore of the plug up to the fiber end. The socket and the plug with the funnel-shaped section of this known plug-in connection are produced from plastic, preferably as injection-molded parts.

In a further plug-in connection, which is known in practice and constructed in a fashion similar to the embodiment in accordance with EP 0 898 186 A1, the optical fiber is not surrounded by a tube, but its end projects freely into the funnel-shaped section of the plug. The plug with the funnel-shaped inner surface is manufactured from metal, specifically high grade steel, by turning, and is mostly also redressed. When the plug and socket are plugged together, the funnel serves as a guiding and centering aid for the light guide.

It is an object of the invention to provide a novel optical coupling device for light guides.

This object is achieved by means of the subject matter in accordance with patent claim 1. Advantageous refinements and developments in accordance with the invention follow from the claims dependent on claim 1.

The coupling device (optical coupler) for connecting a light guide to at least one further light guide and/or to at least one optical component comprises a first coupling element with a first passage for holding an end region of the light guide, and a second coupling element with a second passage for holding a section of the light guide, the first coupling element and the second coupling element being capable of being detachably joined, or being detachably joined in a coupled state, and the first passage and the second passage forming a common passage in the coupled or joined state (or: facing one another with their outlet regions, or merge into one another) and/or have or surround a common longitudinal axis. The first passage of the first coupling element has a funnel-shaped section (or: funnel-shaped inlet region, inlet funnel) that widens toward the second coupling element in the coupled state. At least in the region of the funnel-shaped section, the first coupling element is then produced, at least on the inner surface thereof, from ceramic material (or: ceramic).

The invention proceeds from the surprising observation that despite the flexibility of the fiber and the funnel shape of the bore in the plug, in some practical cases the sensitive end of the optical fiber suffers damage when this fiber end slides along the funnel surface. Investigations thereupon set up by the inventor revealed that the funnel of the plug in the known coupling devices nevertheless has surface roughnesses and unevennesses on the inner side that are comparatively large by comparison with the fiber cross section, and this being so despite the processing of the surfaces. The turning produces furrows in the funnel made from high grade steel, and even the plastic injection-molded part also has a relatively high surface roughness owing to its material properties. The furrows and the rough surface in the funnel can cause the optical glass fibers to splinter and/or break off and/or be damaged at their ends. The optical fibers are thereby rendered useless.

In order to solve or allay this problem, it is provided in accordance with the invention that, at least in the region of the funnel-shaped section of the first passage, the first coupling element consists of a ceramic material at least on the inner surface.

Even without subsequent treatment by polishing or similar measures, parts or layers made from a ceramic material can be produced with a particularly smooth surface. When the end region of the light guide strikes the inner surface of the funnel, the light guide can slide along this inner surface without becoming stuck at a depression or elevation on the surface. Consequently, the risk of the light guide being damaged during joining of the coupling elements is substantially diminished. The funnel-shaped section of the first passage can now be used or provided without any problem for positioning or guiding, in particular centering, the light guide end during insertion (or: threading) into the first passage of the first coupling element, and the insertion of the light guide is generally made easier.

In a particularly advantageous embodiment, the first passage of the first coupling element has a second section that adjoins the funnel-shaped section and is arranged in the coupled state on the side of the funnel-shaped section that is averted from the second passage, and preferably holds the free end and a directly adjacent first part of the end section of the light guide and adjusts it in such a way that an optical axis of the light guide is substantially aligned at the free end thereof along a longitudinal axis of this second section. The inside diameter of this second section of the first passage is expediently substantially constant and adapted to the outside diameter of the light guide, which is substantially constant at least in the end section, so that the light guide fits accurately or is seated in a form-fitting fashion.

The coupling device in accordance with the invention is provided in general for connecting the light guide to at least one further light guide and/or to at least one optical component, in particular a light-emitting component, for example a laser or a laser diode or an LED, or a light detecting component, in particular a photoelectric component such as a phototransistor or a photodiode, or a light applying instrument, for example a handheld instrument for applying the (laser) light, in which case the further light guide and/or the optical component can be, or are or is connected to or in the first passage of the first coupling element, in particular to or in the second section of the first passage on the side averted from the funnel-shaped section. In the connected state, the further light guide is preferably held with its free end and an adjoining end section in the second section of the first passage and is adjusted in such a way that an optical axis of the light guide is substantially aligned at the free end thereof along a longitudinal axis of this second section, and the free ends of the two light guides lie opposite one another. In order also to facilitate the insertion and centering of the further light guide, the first passage can then advantageously have a third section that expands in a funnel-shaped fashion away from the second section.

Furthermore, it is possible to provide at least one third coupling element for holding the further light guide and/or the at least one optical component, in which the third coupling element can be detachably joined or is detachably joined in a coupled state. This third coupling element now preferably has a third passage for holding and/or fixing an intermediate section, following the end section, of the further light guide. In particular, in the coupled state the first passage of the first coupling element and the third passage of the third coupling element also form a common passage and/or have or surround a longitudinal axis.

It is particularly advantageous when the common longitudinal axis of the first passage and second or third passage is a longitudinal central axis or a central longitudinal axis such that an axial arrangement of the light guide in the coupling device is then substantially enabled without bending the light guide.

The first coupling element can be constructed in one piece or one part, or else alternatively from two or more prefabricated parts that are fastened or connected on one another or to one another, at least one part with the funnel-shaped section of the first passage being produced or formed from the ceramic material at least on the inner surface thereof. The outlay on mounting is less in the case of a design in one part. By contrast, in the case of a multipartite design, the funnel-shaped section has the desired smooth surface, while the materials for the remaining parts of the first coupling element can be selected in targeted fashion in accordance with the requirements.

In a part of the first coupling element that has the first passage or at least the funnel-shaped section of the first passage, the first coupling element can be produced or formed completely or only partially from ceramic material, in particular the same ceramic material. In an advantageous embodiment, the entire first passage is formed or manufactured, at least on its inner surface, from ceramic material. This embodiment is particularly advantageous in combination with the embodiment in which the first passage has a further section, adjoining the funnel-shaped section, for holding the light guide end, and the light guide end therefore also possibly slides or drags on the inner surface of this further section upon being inserted.

In the event of the formation of the entire coupling element or its parts from solid ceramic material, it is preferred to apply a primary forming process that comprises the production steps typical of the production of a ceramic, in particular
the shaping of a blank from the finely divided starting materials or raw materials,
the ceramic baking or the sintering of the blank, generally previously dried, and
subsequent treatment, if appropriate.

Coming chiefly into consideration as shaping processes are casting methods with a flowable starting composition, preferably injection molding, but also powder compression methods or powder pressure methods with the aid of pulverulent starting materials.

Alternatively, the first coupling element can also be formed entirely, or in said part with the first passage or its funnel-shaped section, from a basic body and a surface layer made from the ceramic material. The basic body can in this case consist of a metal, in particular aluminum or an aluminum alloy or a steel. In addition, an intermediate layer, in particular for promoting adhesion, and/or a chromium-nickel layer can be provided between the basic body and surface layer made from ceramic material. The ceramic surface layer can be applied by spraying, in particular thermal spraying or plasma spraying.

The ceramic material of the coupling device is expediently selected or optimized with regard to a good sliding behavior or a low slippage resistance or coefficient of kinetic friction of the light guide on the ceramic surface of the first passage, in particular in the funnel-shaped section.

In particular, it is ensured that the ceramic material has a sufficiently low surface roughness or a sufficiently smooth surface. The surface roughness, in particular the arithmetic mean Ra, is preferably selected to be small by comparison with the dimensions of the light guide cross section, which typically lie in the range from 100 μm to 1000 μm, preferably 200 μm to 800 μm, for example a factor of at least 50, preferably at least 100, smaller than the light guide diameter, and/or lies, in particular, below one, or at most at one of the following values: 3 μm, 2.5 μm, 2 μm, 1.5 μm, 1 μm, 0.5 μm.

Surface roughnesses of 1.5 μm to 3 μm can be achieved as “standard” surfaces of ceramic molded parts or ceramic layers that are a result of primary formation and have been produced by standard coating methods such as thermal spraying or plasma spraying, without further reworking or redressing. The surface can be additionally polished or finely reworked in some other way for lower surface roughnesses. It is possible thereby even to set surface roughnesses of 0.3 μm and below. By comparison therewith, in the prior art the steel surface has a roughness of at least 20 μm even in the case of fine surface machining.

The ceramic material preferably comprises (includes or consists of) at least one oxide ceramic material, in particular one or more from the group of oxide ceramic materials comprising aluminum oxide, titanium dioxide, chromium oxide, magnesium oxide, beryllium oxide and zirconium dioxide. Particularly suitable for ceramic layers, but not restricted thereto, is a ceramic having a mixture or a composition of two or more of said oxide ceramics, preferably of aluminum oxide and/or chromium oxide having a fraction of titanium dioxide for stabilization, preferably a composition having a fraction of aluminum oxide of between 60% and 97% (percentage by weight) and a fraction of titanium dioxide of between 3% and 40%, or a fraction of chromium oxide in a range from 40% to 60% and a fraction of titanium dioxide in a range from 40% to 60%.

However, it is also possible to use nonoxidic ceramics, in particular carbides, for example silicon carbide, or nitrides, or else silica-containing ceramics, in particular porcelain and/or with a glaze.

The second coupling element and/or third coupling element can be formed from plastic and/or be designed as an injection-molded part, but also from ceramic material, in particular with similar specifications as those described with the aid of the first coupling element.

In particular, the second coupling element is designed as a Luer push-on socket or a Luer push-on plug, and the first coupling element is designed as a Luer push on plug or a Luer push-on socket.

In an advantageous embodiment, the connection of first coupling element, on the one hand, and second or third coupling element, on the other hand, is a plug-in connection, but it can also be a screw connection.

Furthermore, according to the invention the use of the above-described coupling device inside an appliance of medical technology is provided, preferably for a surgical system. Numerous operations are carried out with the aid of laser light. Even locations in the body that are difficult to access can be treated in this case with laser light. Furthermore, the above coupling device can also be used for an endoscopic system. Moreover, the above coupling device can be used in a system that is provided for operations on the human or animal eye, in particular for operations on the lens, for example for treating the cataract or for operations on the cornea in order to correct ametropia.

In a particularly advantageous embodiment, the coupling device connects a laser to a handheld instrument. In particular, a laser system for laser light application on the human or animal body, in particular the eye, has a laser and a handheld instrument and at least one light guide, as well as at least one coupling device for the light guide in order to transmit the light of the laser to the handheld instrument.

Preferred embodiments of the coupling device according to the invention are explained in more detail below with reference to the attached drawings, in which:

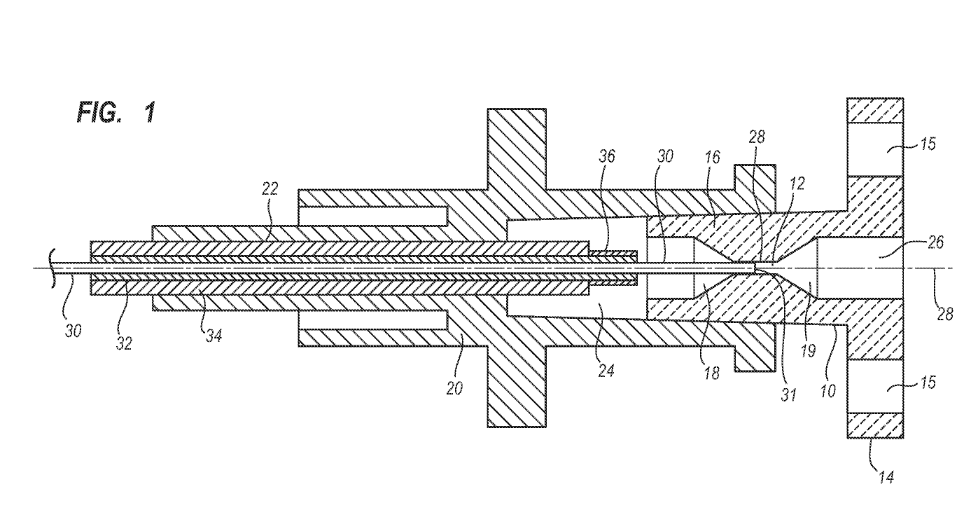

FIG. 1 shows a sectional view of a preferred embodiment of the coupling device;

FIG. 1 shows a sectional view of a further preferred embodiment of the coupling device;

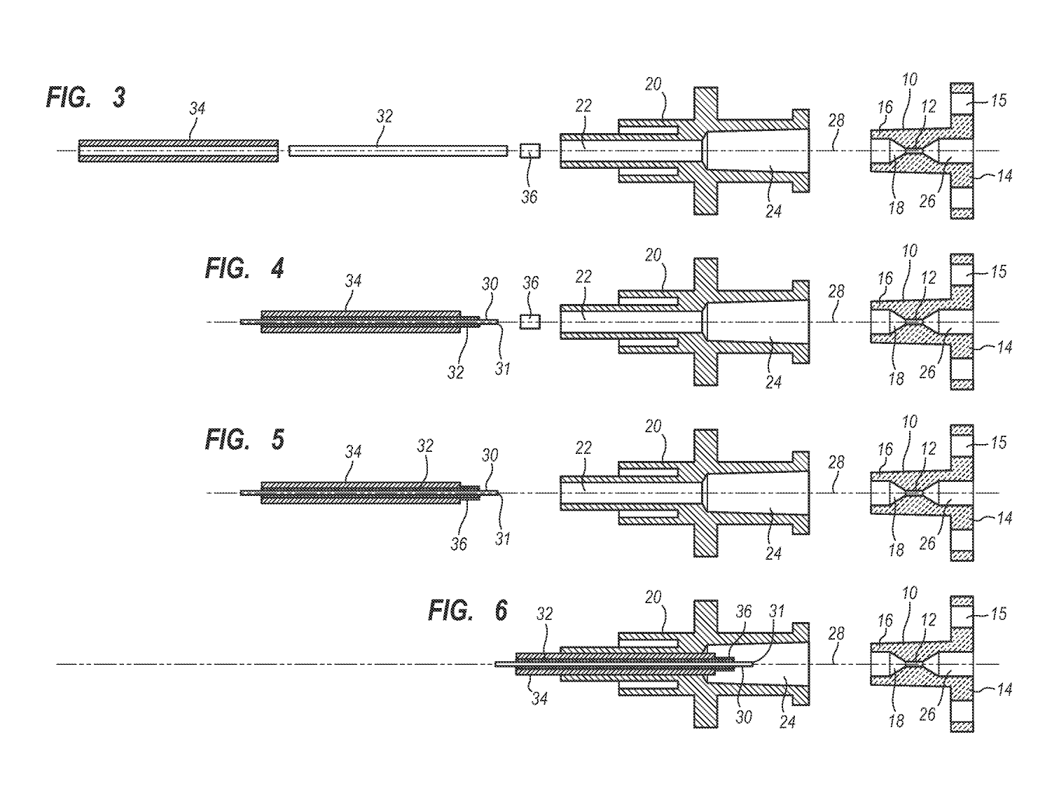

FIG. 3 shows an illustration of a first method step of the assembly of a coupling element;

FIG. 4 shows an illustration of a second method step of the assembly of the coupling element;

FIG. 5 shows an illustration of a third method step of the assembly of the coupling element; and

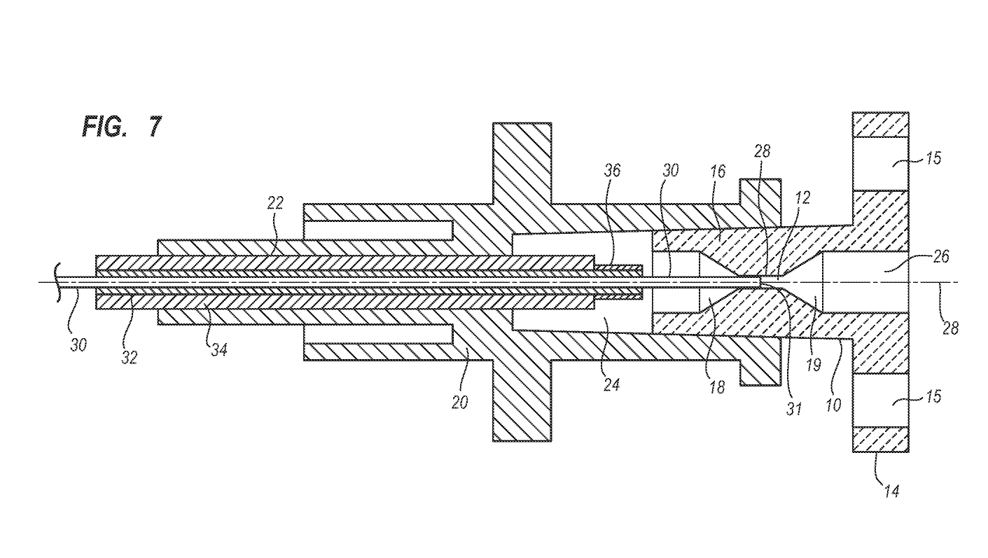

FIG. 6 shows an illustration of a fourth method step of the assembly of the coupling element.

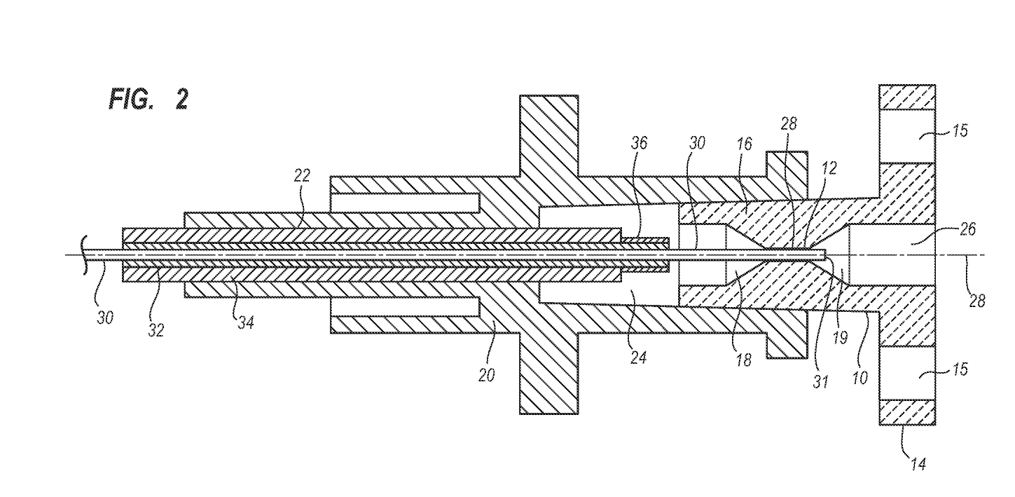

FIG. 1 and 2 illustrate a preferred embodiment of the coupling device. The coupling device comprises a first coupling element 10 and a second coupling element 20. In this particular embodiment, the first coupling element is designed as a plug 10 and the second coupling element as a socket 20. The plug 10 and the socket 20 can be plugged together. In FIG. 1, the plug 10 and the socket 20 are in the state when plugged together.

Generally, in the case of the coupling device in accordance with the invention, the coupling elements 10 and 20 can be designed as molded parts that can be detachably joined, in particular plugged together or screwed together.

In the embodiment illustrated, the socket 20 is designed as a commercially available Luer push-on socket. Furthermore, the socket 20 is designed in one piece and as an injection-molded part. The plug 10 takes the form of a commercially available Luer push on plug.

The first coupling element 10 is produced in its entirety, or at least in the region of the first passage 12, from a ceramic material. The ceramic material comprises, in particular, an oxide ceramic, preferably aluminum oxide (Al₂O₃), with the aid of which the part can be produced with a smooth surface in a cost-effective fashion, in particular by shaping and baking without further reworking.

The plug 10 has a base part 14 that is designed in the manner of a flange. Located in the base part 14 are bores 15 that enable the base part 14 to be fastened to an apparatus or the like. Extending outward from the base part 14 is an elongated extension 16 that is of conical design. The angle of the cone at the extension 16 amounts in this particular embodiment to 1.5°.

The plug 10 has an elongated first passage 12 that penetrates the extension 16 and the base part 14. Here, the longitudinal axes of the extension 16 and of the first passage 12 are of coaxial design relative to one another. Moreover, the extension 16 and the first passage 12 are arranged concentrically relative to one another.

The first passage 12 comprises a funnel-shaped section 18 that is located in the extension 16 and tapers toward the base part 14 and is, in particular, of conical design.

The first passage 12 has a widened portion 26 in the region of the base part 14. The widened portion 26 is provided, in particular, for holding an optical component or a further light guide. The optical component can be both a light emitting and also a light-sensitive component as well as a light applying component, for example a handheld instrument for surgical or therapeutic operations, particularly on the eye.

The plug 10 is designed in one piece in the embodiment illustrated. In an alternative embodiment, the plug 10 can also be designed in a multiplicity of parts, at least the part that comprises the funnel-shaped section 18 being produced from the ceramic material. Moreover, it is also possible to coat only the inner surface with ceramic.

The socket 20 has a cutout 24 that is designed to complement the extension 16. The diameter of the cutout 24 tapers with increasing distance from the plug 10. The angle of the cone of the cutout 24 likewise amounts to 1.5°.

The socket 20 has a second passage 22 that has a common longitudinal central axis A in the state when joined with the first passage 12 of the plug 10. The passage 22 has a circular cross section.

Located in the passage is a first tube section 32 and a second tube section 34. The outside diameter of the second tube section 34 corresponds approximately to the inside diameter of the second passage 22. The outside diameter of the first tube section 32 corresponds approximately to the inside diameter of the second tube section 34. The second tube section 34 is arranged in the second passage 22. The second tube section 34 is slightly longer than the second passage 22. The first tube section 32 is arranged in the second tube section 34.

Located in the first tube section 32 is a section of an elongated light guide 30, preferably designed as a one piece optical fiber or glass fiber, having a free end 31. The first tube section 32 effects a stabilization of the light guide 30. Furthermore, with its free end 31, the end region of the light guide 30 projects from the first tube section 32. The inside diameter of the first tube section 32 and of the central section 28, as well, of the first passage 12 corresponds approximately to the outside diameter of the light guide 30.

In FIG. 1, the light guide 30 terminates with its free end 31 in a central region or section 28 of the first passage 12, preferably approximately in the middle. This embodiment in accordance with FIG. 1 is particularly suitable for connecting a further light guide that is inserted from the other side into the central section 28.

In FIG. 2, the light guide 30 is led through the entire central section 28 of the first passage 12, and the free end 31 of the light guide 30 projects into the widened portion 26.

The funnel-shaped section 18 has the effect that the end section of the light guide 30 having the free end 31 is reliably inserted into or centered in the central region of the first passage 12 when the first coupling element 10 is joined to the second coupling element 20. The ceramic material has a particularly smooth surface on the inside of the funnel-shaped section 18, and so the risk of damage to the light guide 30 when the first coupling element 10 is joined to the second coupling element 20 is slight.

A corresponding funnel-shaped section 19 that opens into the central section 28 at the side averted from the funnel-shaped section 18 can facilitate the insertion of the further light guide, particularly in accordance with FIG. 1.

FIG. 3 to FIG. 6 illustrate how and in what sequence the second coupling element 20, the first tube section 32, the second tube section 34 and the sleeve 36 are joined.

In FIG. 3, the second tube section 34, the first tube section 32, the sleeve 36, the second coupling element 20 and the first coupling element 10 are illustrated as individual parts and aligned as in FIG. 1.

In FIG. 4, the first tube section 32 is inserted into the second tube section 34, the first tube section 32 being flush with the second tube section 34 on the side averted from the first coupling element 10.

In FIG. 5, the sleeve 36 is slipped over, the first tube section 32, the sleeve 36 being directly connected to the second tube section 34. The first tube section 32 and the second tube section 34 are mutually fixed by the sleeve 36.

In FIG. 6, the first tube section 32, the sleeve 36 and the second tube section 34, which are joined to form one part, are inserted into the second coupling element 20. Here, the end of the first tube section 32 that faces the first coupling element 10 is still located inside the cutout 24.

The tube sections 32 and 34 can also be omitted when the light guide 30 is fixed directly in the second passage 22, for example by means of adhesive, or in a force-closed fashion.

The coupling device according to the invention is suitable for applications in medical technology, in particular for endoscopic and surgical systems and appliances. The coupling device can be provided for equipment and systems that are used in an eye operation. Such items of equipment are used, for example, in the cataract operation for removing the old eye lens when artificial lenses are subsequently implanted. Such items of equipment are also used for cornea operations in order to correct ametropia.

The hygiene conditions are particularly important in the case of medical applications. For this reason, the coupling device according to the invention is provided as a disposable article, for example. Alternatively, or in addition, the coupling device according to the invention can be sterilized.

The light guide 30 is provided, in particular, for the transmission of visible light and infrared light, in particular coherent light, that is to say light of constant phase relationship. The light is preferably produced for the light guide 30 by a laser, for example a CO₂ laser or diode laser or a neodymium-YAG laser.

### LIST OF REFERENCE SYMBOLS

10 First coupling element, plug
12 First passage
14 Base part
15 Bore
16 Extension
18 Funnel-shaped section
19 Section
20 Second coupling element, socket
22 Second passage
24 Cutout
26 Widened portion
28 Section
30 Light guide
31 Free end
32 First tube section
33 End section
34 Second tube section
35 Intermediate section
36 Sleeve
A Longitudinal central axis

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. A coupling device for connecting a light guide, comprising:
a) a first coupling element with a first passage for holding a free end of the light guide, and an end section connected to the free end of the light guide, and
b) a second coupling element with a second passage for holding and/or fixing an intermediate section, following the end section, of the light guide;
wherein:
c) the first coupling element and the second coupling element can be detachably joined or are detachably joined in a coupled state;
d) in the coupled state, the first passage and the second passage form a common passage and/or have or surround a common longitudinal axis;
e) the first passage has a funnel-shaped section that, in the coupled state, faces the second passage and widens toward the second passage;
and wherein:
f) at least in the region of the funnel-shaped section, the first coupling element is formed or made from ceramic material at least on its inner surface.

50. The coupling device as claimed in claim 49, wherein the first passage of the first coupling element has a second section that adjoins the funnel-shaped section and is arranged in the coupled state on the side of the funnel-shaped section that is averted from the second passage.

51. The coupling device as claimed in claim 7, wherein:
in the coupled state, the second section of the first passage holds the free end and a directly adjoining first part of the end section of the light guide and adjusts them in such a way that an optical axis of the light guide is substantially aligned at the free end thereof along a longitudinal axis of this second section; and/or
the second section of the first passage has a substantially constant inside diameter, and, at least in the end section, the light guide has a substantially constant outside diameter, and wherein the inside diameter of the second section of the first passage is adapted to the outside diameter of the light guide.

52. The coupling device as claimed in claim 49 for connecting the light guide to at least one further light guide and/or to at least one optical component, in particular a light emitting component or a light detecting component or a light applying instrument, wherein:
the further light guide and/or the optical component can be, or are or is connected to or in the first passage of the first coupling element;
the further light guide and/or the optical component can be, or is connected to or in the second section of the first passage on the side averted from the funnel-shaped section; and/or
in the connected state, the further light guide is held with its free end and an adjoining end section in the second section of the first passage and is adjusted in such a way that an optical axis of the light guide is substantially aligned at the free end thereof along a longitudinal axis of this second section, and the free ends of the two light guides lie opposite one another.

53. The coupling device as claimed in claim 52, in which the first passage has a third section that expands in a funnel-shaped fashion away from the second section.

54. The coupling device as claimed in claim 52, having at least one third coupling element for holding the further light guide and/or the at least one optical component, wherein:
the third coupling element can be detachably joined or is detachably joined with the first coupling element in a coupled state;
preferably the third coupling element has a third passage for holding and/or fixing an intermediate section following the end section of the further light guide; and
preferably in the coupled state, the first passage of the first coupling element and the third passage of the third coupling element form a common passage and/or have or surround a common longitudinal axis.

55. The coupling device as claimed in claim 49, wherein:
the first coupling element is designed in one piece or one part; and/or
the first coupling element is produced or formed completely from ceramic material, in particular the same ceramic material.

56. The coupling device as claimed in claim 49, wherein the first coupling element comprises two or more prefabricated parts fastened on or to one another, at least one part with the funnel-shaped section of the first passage being produced or formed from the ceramic material at least on the inner surface thereof.

57. The coupling device as claimed in claim 49, wherein the ceramic material comprises at least one oxide ceramic material.

58. The coupling device as claimed in claim 57, wherein the oxide ceramic material comprises at least one of the members of the set comprising aluminum oxide, titanium dioxide, chromium oxide, magnesium oxide, beryllium oxide, and zirconium dioxide.

59. The coupling device as claimed in claim 58, wherein:
the oxide ceramic material has a fraction of aluminum oxide in a range from 60% to 97%, and a fraction of titanium dioxide in a range from 3% to 40%; or
wherein the oxide ceramic material has a fraction of chromium oxide in a range from 40% to 60%, and a fraction of titanium dioxide in a range from 40% to 60%.

60. The coupling device as claimed in claim 49, wherein:
the first coupling element or a part of the first coupling element that has the first passage or at least the funnel-shaped section of the first passage is formed from a molded part, resulting from primary forming, of the ceramic; and
preferably at least in the funnel-shaped section, the inner surface of the first passage is reworked, in particular repolished.

61. The coupling device as claimed in claim 49, wherein the first coupling element or a part of the first coupling element that has the first passage or at least the funnel-shaped section of the first passage is formed from a basic body with a surface layer made from the ceramic material.

62. The coupling device as claimed in claim 61, wherein:
the basic body is formed from a metal, in particular aluminum or an aluminum alloy or a steel;
an intermediate layer, in particular for promoting adhesion, and/or a chromium-nickel layer is/are arranged between the basic body and surface layer made from ceramic material; and/or
the surface layer made from ceramic material is sprayed onto the basic body or the intermediate layer, in particular by thermal spraying or plasma spraying.

63. The coupling device as claimed in claim 49, wherein:
at least in the funnel-shaped section, the surface roughness of the inner surface of the first passage amounts to at most one-fiftieth ( 1/50), preferably at most one-hundredth ( 1/100), of the cross-sectional dimension or of the diameter of the light guide; and/or
at least in the funnel-shaped section, the inner surface of the first passage has a surface roughness of at most 3 μm or 2.5 μm or 2 μm or 1.5 μm or 1 μm or 0.5 μm.

64. The coupling device as claimed in claim 49, wherein:
the second coupling element is formed from plastic and/or is designed as an injection molded part; or
the second coupling element is produced from ceramic material.

65. The coupling device as claimed in claim 49, wherein:
the second coupling element is designed as a Luer push-on plug or a Luer push-on socket; and
the first coupling element is designed as a Luer push-on plug or a Luer push-on socket.

66. The coupling device as claimed in claim 49, wherein:
the first and second and/or the third coupling element can be, or are, joined by being plugged together;
the first and second and/or the third coupling element can be joined by means of at least one fastening element; and/or
the first and second and/or the third coupling element can be joined by means of at least one screw connection.

67. The coupling device as claimed in claim 49, having the connected light guide.

68. The coupling device as claimed in claim 49, wherein the light guide diameter is in the range from 100 μm to 1000 μm, preferably 200 μm to 800 μm.

69. The coupling device as claimed in claim 49 for use inside any one or more of:
a medical appliance;
a surgical system;
an endoscopic system;
in a system that is provided for operations on the eye;
in a system for operations on the lens, in particular for treating a cataract;
in system for operations on the cornea in order to correct ametropia.

70. The coupling device as claimed in claim 69, which optically connects a laser to a handheld instrument.

71. A laser system for laser application on the human or animal body, in particular the eye, having a laser and a handheld instrument, and having at least one light guide and at least one coupling device as claimed in claim 49 for the purpose of transmitting the light of the laser to the handheld instrument.
